(19) United States
(12) Patent Application Publication
(10) Pub. No.: US 2002/0187713 A1
(43) Pub. Date: Dec. 12, 2002

(54) Three-valve exhaust system for index reduction

(76) Inventor: Christopher Monks, Greensburg, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/878,688

(22) Filed: Jun. 11, 2001

(51) Int. Cl. H01J 9/38

(52) U.S. Cl. 445/38; 445/73

(57) ABSTRACT

During the manufacture of CRT's a manufacturing step requires that a vacuum be drawn on all CRT's while baking in an exhaust oven. This process is usually performed simultaneously on a plurality of CRT's connected to an exhaust cart by a manifold. The present invention provides a method and apparatus to reduce processing times by utilizing a roughing pump and diffusion pump to alternately evacuate a CRT being processed while isolated from one another. The methodology allows the diffusion pump to remain at a high vacuum level at all times therefore eliminating the need for lengthy warm up of the diffusion pump each time a CRT is processed.

### FIELD OF THE INVENTION

The present invention relates generally to methods and apparatuses for manufacturing Cathode Ray Tubes (CRTs), and more particularly to a method and apparatus for manufacturing CRTs that requires generation and maintenance of a vacuum on multiple CRT's during the manufacturing process.

### BACKGROUND OF THE INVENTION

Cathode Ray tubes need to possess a vacuum to permit an electron beam to travel through the bodies of the CRT's and be projected on the CRT screen without the interference of air molecules. During the manufacture of CRT's, units are typically evacuated to a vacuum by using a roughing pump to draw a vacuum down to the approximately 10⁻³ Torr level, after which a High Vacuum Diffusion Pump (DP) continues to pull the vacuum to a final level of approximately 10⁻⁶ Torr. Typically, the roughing pump draws a vacuum through the body of the DP while the DP heats up and achieves full efficiency. Once the DP achieves optimum efficiency, it draws the vacuum down to the final low level. Once the cycle I complete the DP is switched off. The cycle is repeated when a subsequent CRT needs to be evacuated. Consequently, the DP is cycled on and off with each CRT that is loaded and requires approximately 30 minutes to warm up and achieve optimum efficiency in each instance. Such cycling is time consuming and actually reduces the life of the pump due to the continuous cycling.

The present invention is therefore directed to the problem of developing a method and apparatus for manufacturing CRTs in which the above cycling is avoided.

### SUMMARY OF THE INVENTION

The present invention solves this problem by providing a CRT exhaust system that utilizes flow switching valves and additional piping to permit the roughing pump and diffusion pump to exhaust a CRT in tandem, or to be sealed off from one another and to individually exhaust a CRT depending on the configuration of a series of flow controlling valves.

According to one aspect of the present invention, a method for creating a vacuum in a vacuum extraction manifold comprises creating a first vacuum level in a vessel by evacuating a gas in the vessel with a first evacuator; detecting the first vacuum level; isolating the first evacuator from the vessel in response to detection of the first vacuum level; creating a second vacuum level in the vessel by further evacuating the gas in the vessel with a second evacuator; detecting the second vacuum level; isolating the second evacuator from the vessel in response to detection of the second vacuum level; and maintaining the second vacuum level in the second evacuator.

According to another aspect of the present invention, in the above method the first vacuum level is 760 torr.

According to another aspect of the present invention, in the above method the vessel comprises a CRT connected to a piping manifold.

According to another aspect of the present invention, in the above method the first evacuator comprises a roughing pump.

According to another aspect of the present invention, in the above method the isolating step comprises closing at least one valve between said first evacuator and said vessel.

According to another aspect of the present invention, in the above method the at least one valve comprises a solenoid valve.

According to yet another of the present invention, in the above method the second vacuum level comprises 0.1 mbar.

According to another aspect of the present invention, in the above method the second evacuator comprises a diffusion pump.

According to another aspect of the present invention, in the above method the gas comprises atmospheric air.

According to another aspect of the present invention, in the above method the first predetermined time interval includes 7.5 minutes.

According to another aspect of the present invention, a method for creating a vacuum in a vacuum extraction manifold comprises creating a first vacuum level in a vessel by evacuating a gas in the vessel with a first evacuator for a first predetermined time interval; isolating the first evacuator from the vessel; creating a second vacuum level in the vessel by further evacuating the gas in the vessel with a second evacuator for a second predetermined time interval; isolating the second evacuator from the vessel; and maintaining the second vacuum level in the second evacuator.

According another aspect of the present invention, in the above method the first vacuum level is 760 torr.

According to another aspect of the present invention, in the above method the first vacuum level the vessel comprises a CRT connected to a piping manifold.

According to another aspect of the present invention, in the above method, the first evacuator is a roughing pump.

According to another aspect of the present invention, in the above method, the isolating step comprises closing at least one valve between said first evacuator and said vessel.

According to another aspect of the present invention, in the above method, the at least one valve comprises a solenoid valve.

According to yet another aspect of the present invention, in the above method, the second vacuum level comprises 0.1 mbar.

According to another aspect of the present invention, in the above method, the second evacuator comprises a diffusion pump.

According to another aspect of the present invention, in the above method, the gas comprises atmospheric air.

According to another aspect of the present invention, in the above method, the first predetermined time interval includes 7.5 minutes.

According to another aspect of the present invention, in the above method, the second predetermined time interval comprises 7 minutes and 33 seconds.

According to yet another aspect of the present invention, a device for creating a vacuum in a vacuum extraction manifold comprises a first evacuator, the first evacuator being operatively connected to a manifold port and a vessel by a piping network, the piping network comprising a first flow controller, a second flow controller and a third flow controller; and a second evacuator, said second evacuator being operatively connected to the piping network, wherein when the first, second and third flow controllers are set in a first configuration, the first evacuator is isolated from the second evacuator and independently evacuates the vessel to a first vacuum level, and when the first, second and third flow controllers are set in a second configuration, the second evacuator is isolated from said the evacuator and independently evacuates the vessel to a second vacuum level

According to another aspect of the present invention in the above device, the first evacuator comprises a roughing pump.

According to another aspect of the present invention in the above device, the vessel comprises a cathode ray tube.

According to another aspect of the present invention in the above device, the first, second and third flow controllers comprise first, second and third solenoid valves, respectively.

According to another aspect of the present invention in the above device, the second evacuator comprises a diffusion pump.

According to another aspect of the present invention in the above device, the first vacuum level comprises 760 torr.

According to another aspect of the present invention in the above device, the second vacuum level comprises 0.1 mbar.

### BRIEF DESCRIPTION OF THE DRAWINGS

FIG. 1 is a schematic depicting a prior art CRT exhaust system.

FIG. 2 is a schematic depicting a CRT exhaust system in accordance with the present invention.

FIG. 3 is a schematic circuit diagram detailing the control elements of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not all necessarily referring to the same embodiment.

The present invention includes inter alia a method and apparatus for exhausting and drawing a vacuum on a CRT, which method and apparatus includes flow valves implemented as part of an exhaust cart assembly to isolate individually, one of at least two pumps connected to a CRT under preparation when necessary, and to thereby permit the CRT to be evacuated by either pump individually, and permitting a Diffusion Pump in the system to remain operating through all phases of system operation without having to be switched off.

Accordingly, one advantage of the present invention is that it provides a method and apparatus to eliminate diffusion pump shutdown times during CRT manufacture and increases the life span of a diff-usion pump utilized in accordance with the present invention. Typically in the production of small profile CRT's, a vacuum is drawn on every CRT while baking in an Exhaust Oven. This is accomplished by using vacuum carts, wherein each cart is set up to draw a vacuum on one CRT. On each cart, a CRT is evacuated by a roughing pump pulling air through the body of a diffusion pump, while the diffusion pump heats up. Once the diffusion pump reaches it's optimum efficiency, it assumes the task of evacuating the CRT under preparation and continues to evacuate air until the final low-pressure level is reached.

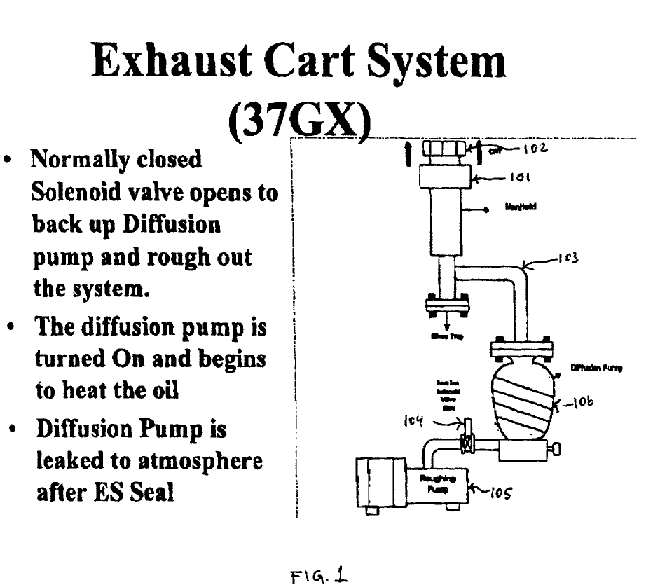

A typical example of such an installation is shown in FIG. 1. As depicted therein, an exhaust manifold port 101, with a connector piece 102 for affixing the manifold port 101 to a CRT (not shown) is connected via piping 103 to a diffusion pump 106 and roughing pump 105.

In operation, solenoid valve 104 is opened, allowing roughing pump 105 to back up diffusion pump 106, and perform the initial evacuation of a CRT connected to port 102. When the diffusion Pump 106 reaches an optimum level, valve 104 is closed and diffusion pump 106 continues to evacuate the system until the desired low pressure level is reached.

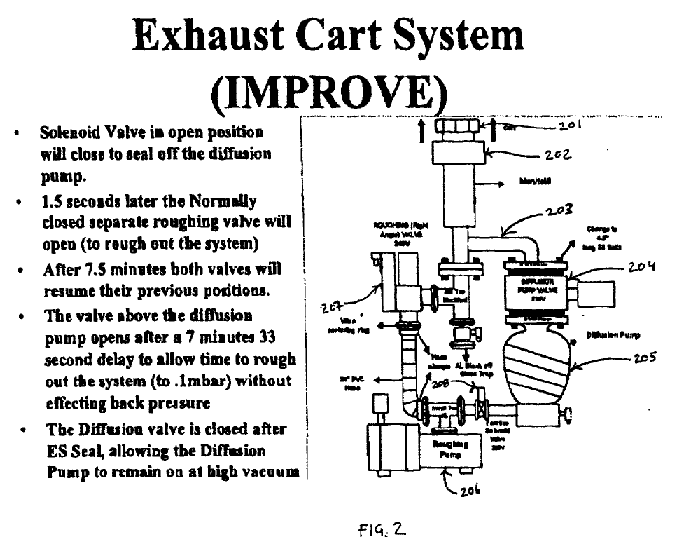

An exemplary embodiment of the present invention is shown in FIG. 2. As depicted therein a manifold port 202 with a connector piece for affixing a CRT (not shown) to manifold port 202 is connected by piping 203 to a diffusion pump 205 and a roughing pump 206. The present invention improves on the prior art by providing a roughing valve 207, diffusion pump valve 204 and bypass valve 208 which, when suitably configured, permit roughing pump 206 to independently evacuate a CRT under preparation while bypassing diffusion pump 205. Alternatively, valves roughing valve 207, diffusion valve 204 and bypass valve 208 can be configured to permit diffusion pump 205 to independently evacuate a CRT under preparation while bypassing roughing pump 206.

In operation, the present invention permits the independent evacuation of a CRT (not shown) through manifold port 202 via diffusion pump 205 or roughing pump 206. In a preferred embodiment of the present invention and with further reference to FIG. 2, when a CRT is to be evacuated, bypass valve 208 is closed to seal off diffusion pump 205. After a predetermined time lapse, 1.5 seconds in a preferred embodiment, normally closed roughing valve 207 opens. Once opened, roughing valve 207 permits evacuation of the CRT under preparation to an initial vacuum level by roughing pump 206. After a predetermined interval, 7.5 minutes in a preferred embodiment, bypass valve 208 and roughing valve 207 are then closed. After a predetermined time lapse, 7 minutes and 33 seconds in a preferred embodiment, diffusion valve 204 is opened. This configuration, wherein roughing valve 207 and bypass valve 208 are closed, while diffusion valve 204 is opened, allows diffusion pump 205 to independently continue the evacuation of a CRT under preparation and evacuate the CRT to a final vacuum level. In a preferred embodiment, the final vacuum level achieved is 0.1 mbar. Once the final vacuum level is reached, the diffusion valve 204 is then closed, thereby allowing the diffusion pump 205 to remain on at the final vacuum level.

By allowing the diffusion pump 205 to achieve the final vacuum level and then isolating diffusion pump at a high vacuum level, shutdown and warm up of diffusion pump 205 is eliminated thereby reducing CRT preparation time and thereby increasing the longevity of diffusion pump 205. Moreover contaminants and other impurities are prevented from entering diffusion pump 205, by first evacuating a CRT under preparation with roughing pump 206. In a preferred embodiment, the operation of the valves of the present invention is accomplished by an electronic circuit which controls the operation of roughing valve 207, diffusion valve 204 and bypass valve 208.

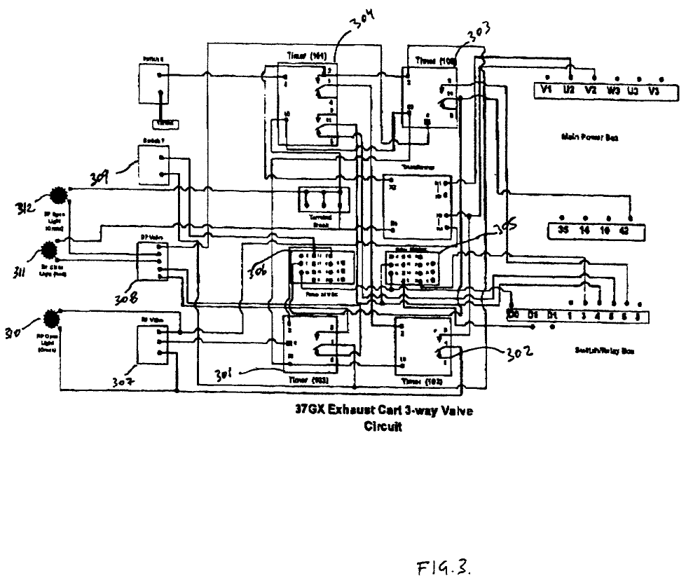

The electronic circuit utilized in a preferred embodiment of the present invention is shown in FIG. 3 although, as can be appreciated by one skilled in the art, any reasonable arrangement of electronic elements and circuits to accomplish the desired valve operations and time sequences can be substituted.

As shown in FIG. 3, timers 301, 302, 303, and 304 operate in conjunction with relays 305 and 306 to operate roughing valve switch 307, diffusion valve switch 308 and bypass valve switch 309. Status light 310 provides an indication of when roughing valve 207 of FIG. 2 is open and status light 311 provides an indication of when diffusion valve 204 of FIG. 2 is closed. Finally, status light 312 provides an indication of when diffusion valve 204 of FIG. 2 is open.

All the features disclosed in this specification (including any accompanying claims, abstract and drawings), and/or all of the steps or any method or process so disclosed, may be combined in any combination, except combinations where at least some of the features and or steps are mutually exclusive. Each feature disclosed in this specification (including any accompanying claims, abstract and drawings) may be replaced by alternative features serving the same equivalent or similar purpose, unless expressly stated otherwise. Thus unless expressly stated otherwise, each feature disclosed is one example only of a generic series of equivalent or similar features. Moreover, although a specific embodiment is specifically illustrated and described herein, it will be appreciated that modifications and variations of the invention are covered by the above teachings and within the purview of the appended claims without departing from the spirit and intended scope of the invention.

What is claimed is:

1. A method for creating a vacuum in a vacuum extraction manifold comprising:
creating a first vacuum level in a vessel by evacuating a gas in said vessel with a first evacuator;
detecting said first vacuum level;
isolating said first evacuator from said vessel in response to detection of said first vacuum level;
creating a second vacuum level in said vessel by further evacuating said gas in said vessel with a second evacuator;
detecting said second vacuum level;
isolating said second evacuator from said vessel in response to detection of said second vacuum level; and
maintaining said second vacuum level in said second evacuator.

2. The method of claim 1, wherein said first vacuum level comprises 760 torr.

3. The method of claim 1, wherein said vessel comprises a CRT connected to a piping manifold.

4. The method of claim 1, wherein said first evacuator comprises a roughing pump.

5. The method of claim 1, wherein said isolating step comprises closing at least one valve between said first evacuator and said vessel.

6. The method according to claim 5, wherein said at least one valve comprises a solenoid valve.

7. The method according to claim 1, wherein said second vacuum level comprises 0.1 mbar.

8. The method according to claim 1, wherein said second evacuator comprises a diffusion pump.

9. The method according to claim 1, wherein said gas comprises atmospheric air.

10. A method for creating a vacuum in a vacuum extraction manifold comprising:
creating a first vacuum level in a vessel by evacuating a gas in said vessel with a first evacuator for a first predetermined time interval;
isolating said first evacuator from said vessel;
creating a second vacuum level in said vessel by further evacuating said gas in said vessel with a second evacuator for a second predetermined time interval;
isolating said second evacuator from said vessel; and
maintaining said second vacuum level in said second evacuator.

11. The method of claim 10, wherein said first vacuum level is 760 torr.

12. The method of claim 10, wherein said vessel comprises a CRT connected to a piping manifold.

13. The method of claim 10, wherein said first evacuator is a roughing pump.

14. The method of claim 10, wherein said isolating step comprises closing at least one valve between said first evacuator and said vessel.

15. The method according to claim 13, wherein said at least one valve comprises a solenoid valve.

16. The method according to claim 10, wherein said second vacuum level comprises 0.1 mbar.

17. The method according to claim 10, wherein said second evacuator comprises a diffusion pump.

18. The method according to claim 10, wherein said gas comprises atmospheric air.

19. The method according to claim 10, wherein said first predetermined time interval includes 7.5 minutes.

20. The method according to claim 10, wherein said second predetermined time interval comprises 7 minutes and 33 seconds.

21. A device for creating a vacuum in a vacuum extraction manifold comprising:
a first evacuator, said first evacuator being operatively connected to a manifold port and a vessel by a piping network, said piping network comprising first flow controller, a second flow controller and a third flow controller; and
a second evacuator, said second evacuator being operatively connected to said piping network, wherein when said first, second and third flow controllers are set in a first configuration, said first evacuator is isolated from said second evacuator and independently evacuates said vessel to a first vacuum level, and when said first, second and third flow controllers are set in a second configuration, said second evacuator is isolated from said first evacuator and independently evacuates said vessel to a second vacuum level.

22. The device according to claim 21, wherein said first evacuator comprises a roughing pump.

23. The device according to claim 21, wherein said vessel comprises a cathode ray tube.

24. The device according to claim 21, wherein said first, second and third flow controllers comprise first, second and third solenoid valves, respectively.

25. The device according to claim 21, wherein said second evacuator comprises a diffusion pump.

26. The device according to claim 21, wherein said first vacuum level comprises 760 torr.

27. The device according to claim 21, wherein said second vacuum level comprises 0.1 mbar.
